(19) United States
(12) Patent Application Publication
(10) Pub. No.: US 2026/0148431 A1
(43) Pub. Date: May 28, 2026

(54) PROCESSING METHOD AND APPARATUS FOR INTERACTIVE MULTIMEDIA CONTENT, DEVICE, MEDIUM AND PRODUCT

(71) Applicant: Beijing Zitiao Network Technology Co., Ltd., Haidian District, Beijing (CN)

(72) Inventor: Yifan LI, Beijing (CN)

(21) Appl. No.: 19/120,114

(22) PCT Filed: Mar. 7, 2024
(86) PCT No.: PCT/CN2024/080501

§ 371 Date: Apr. 10, 2025

(51) Int. Cl. G06T 11/00; G06F 40/166

(52) U.S. Cl. CPC G06T 11/00; G06F 40/166

(57) ABSTRACT

The present disclosure relates to a processing method and apparatus for interactive multimedia content, a device, a medium and a product, and relates to the field of computer technology. The processing method for interactive multimedia content includes: generating a content text of one or more side stories according to a content text of an original story; generating images based on the content text of the original story and the content text of the one or more side stories, wherein the images comprise an image of a character and an image of a scene; and generating the interactive multimedia content according to the content text of the original story, the content text of the one or more side stories and the images.

### TECHNICAL FIELD

The present disclosure relates to the field of computer technology, in particular to a processing method and apparatus f or interactive multimedia content, a device, a medium and a product.

### BACKGROUND

The interactive multimedia content is content that integrates a plurality of elements such as images, sounds and texts, and can provide an interactive interface for a user, such as interactive stories, interactive movies, interactive TV dramas and games. Compared with traditional novels, films and the like, the interactive multimedia content presents more fun and involvement, so that the user may perform operation and interactions and affect the development of the plot.

The interactive multimedia content which is generally produced by professional designers and developers, needs to be subjected to a series of processes, such as plot creation, drawing by an artist, coding by developers or shooting by organized actors, and post-processing.

### SUMMARY

The summary of this invention is provided to introduce concepts in a concise form, which will be described in detail in the following detailed description. The summary of this invention is neither intended to identify the key features or essential features of the technical solution for which protection is sought, nor intended to limit the scope of the technical solution for which protection is sought.

According to some embodiments of the present disclosure, a processing method for interactive multimedia content is provided. The method comprises: generating a content text of one or more side stories according to a content text of an original story; generating images based on the content text of the original story and the content text of the one or more side stories, wherein the images comprise an image of a character and an image of a scene; and generating the interactive multimedia content according to the content text of the original story, the content text of the one or more side stories and the images.

According to other embodiments of the present disclosure, an interactive multimedia content processing apparatus is provided. The apparatus comprises: a text generating module configured to generate a content text of one or more side stories according to a content text of an original story; an image generating module configured to generate images based on the content text of the original story and the content text of the one or more side stories, wherein the images comprise an image of a character and an image of a scene; and a multimedia generating module configured to generate the interactive multimedia content according to the content text of the original story, the content text of the one or more side stories and the images.

According to still other embodiments of the present disclosure, an electronic device is provided. The electronic device comprises: one or more processors; and one or more memories coupled to the one or more processors for storing instructions that, when executed by the one or more processors, cause the one or more processors to perform the interactive multimedia content processing method in any embodiment of the present disclosure.

According to yet other embodiments of the present disclosure, a computer-readable storage medium is provided. The computer-readable storage medium has a computer program stored thereon that, when executed by a processor, causes the processor to implement the interactive multimedia content processing method in any embodiment of the present disclosure.

According to still other embodiments of the present disclosure, a computer program product is provided. The computer program product includes instructions that, when executed by a processor, cause the processor to implement the interactive multimedia content processing method in any embodiment of the present disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Hereinafter, preferred embodiments of the present disclosure will be described with reference to the accompanying drawings. The accompanying drawings described herein are used to provide a further understanding of the present disclosure, and each of the accompanying drawings together with the following detailed description is included in this specification and forms a part of this specification to explain the present disclosure. It should be understood that, the accompanying drawings in the following description only relate to some embodiments of the present disclosure, but do not constitute a limitation to the present disclosure. In the accompanying drawings:

FIG. 1 shows a flowchart of a processing method for interactive multimedia content according to some embodiments of the present disclosure;

FIG. 2 shows a schematic view of a story line according to some embodiments of the present disclosure;

FIG. 3A shows a schematic view of displaying an image of a character according to some embodiments of the present disclosure;

FIG. 3B shows a schematic view of displaying an image of a scene according to some embodiments of the present disclosure;

FIG. 3C shows a schematic view of displaying an audio according to some embodiments of the present disclosure;

FIG. 4 shows a schematic view of a preview interface according to some embodiments of the present disclosure;

FIG. 5 shows a schematic view of a detail page of a character according to some embodiments of the present disclosure;

FIG. 6 shows a flowchart of a processing method for interactive multimedia content according to other embodiments of the present disclosure;

FIG. 7A shows a schematic view of a character selection interface according to some embodiments of the present disclosure;

FIG. 7B shows a schematic view of a selection interface according to some embodiments of the present disclosure;

FIG. 7C shows a schematic view of a display flow of an interactive multimedia content according to some embodiments of the present disclosure;

FIG. 8 shows a schematic structural view of a processing apparatus for interactive multimedia content according to some embodiments of the present disclosure;

FIG. 9 shows a schematic structural view of an electronic device according to some embodiments of the present disclosure;

FIG. 10 shows a schematic structural view of a computer system according to some embodiments of the present disclosure.

It should be understood that, for ease of description, the sizes of various parts shown in the accompanying drawings are not necessarily drawn according to actual proportional relationships. The same or similar reference numerals are used in various accompanying drawings to denote the same or similar components. Therefore, once an item is defined in one accompanying drawing, it might not be discussed further in subsequent accompanying drawings.

### DETAILED DESCRIPTION

The technical solutions in the embodiments of the present disclosure will be explicitly and completely described below in conjunction with the accompanying drawings in the embodiments of the present disclosure. However, apparently, the embodiments described are merely some of the embodiments of the present disclosure, rather than all of the embodiments. The following description of the embodiments is actually only illustrative, and by no means serves as any limitation to the present disclosure and its application or use. It should be understood that the present disclosure may be implemented in various forms, and should not be construed as being limited to the embodiments set forth herein.

It should be understood that the various steps recited in the method embodiments of the present disclosure may be performed according to different sequences, and/or performed in parallel. In addition, the method embodiments may include additional steps and/or omit to perform the illustrated steps. The scope of the present disclosure is not limited in this respect. Unless specifically stated otherwise, the relative arrangement of components and steps, the numerical expressions, and the values set forth in these embodiments should be construed as merely exemplary, but do not limit the scope of the present disclosure.

The term “comprising” and its variations used in the present disclosure represent an open term that includes at least the following elements/features but does not exclude other elements/features, that is, “including but not limited to”. In addition, the term “including” and its variations used in the present disclosure represent an open term that includes at least the following elements/features, but does not exclude other elements/features, that is, “including but not limited to”. Therefore, comprising and including are synonymous. The term “based on” means “at least partially based on”.

The term “one embodiment”, “some embodiments” or “an embodiment” throughout the specification means that a specific feature, structure, or characteristic described in combination with the embodiment(s) is included in at least one embodiment of the present invention. For example, the term “one embodiment” means “at least one embodiment”; the term “another embodiment” means “at least one additional embodiment”; and the term “some embodiments” means “at least some embodiments”. Moreover, the presences of the phrases “in one embodiment”, “in some embodiments” or “in an embodiment” in various places throughout the specification do not necessarily all refer to the same embodiment, but may also refer to the same embodiment.

It should be noted that the concepts such as “first” and “second” mentioned in the present disclosure are only used to distinguish different devices, modules or units, but not to limit the order or interdependence of functions performed by these devices, modules or units. Unless otherwise specified, the concepts such as “first” and “second” are not intended to imply that the objects thus described have to follow a given order in terms of time, space and ranking, or a given order in any other manner.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

The embodiments of the present disclosure will be described in detail below in conjunction with the accompanying drawings, but the present disclosure is not limited to these specific embodiments. The following specific embodiments may be combined with each other, and the same or similar concepts or processes will not be described in detail in some embodiments. In addition, in one or more embodiments, specific features, structures, or characteristics may be combined by those of ordinary skill in the art in any suitable manner that will be apparent from the present disclosure.

At present, an interactive multimedia content has a plurality of story lines, which are all created by the author in advance. The interactive multimedia content pertains to Professional Generated Content (referred to as PGC for short), and its generation process has a high threshold and usually involves the cooperation between professionals in multiple fields. The interactive multimedia content is difficult to be produced by User Generated Content (referred to as UGC for short), and its generation efficiency is relatively low.

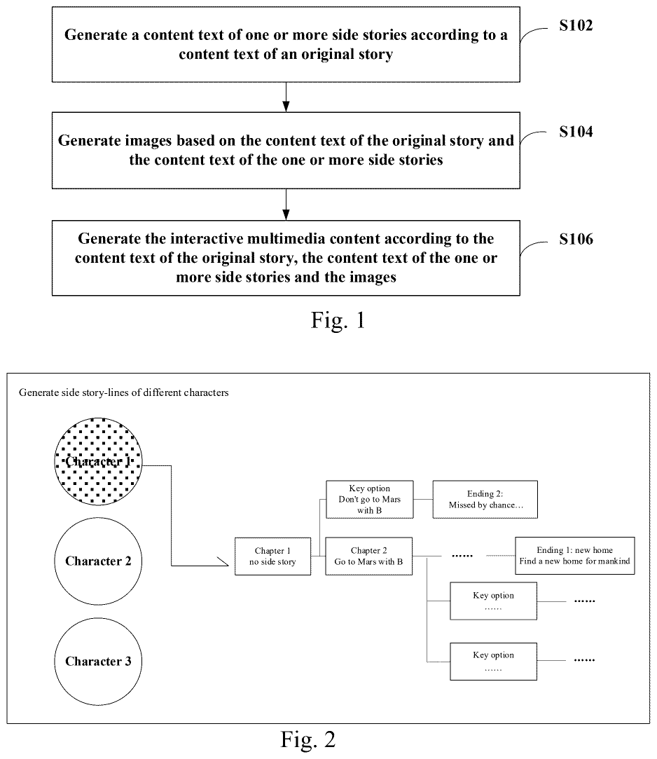

In order to improve the generation efficiency of the interactive multimedia content, the present disclosure provides a processing method for interactive multimedia content. Description will be made below in conjunction with FIGS. 1 to 7C.

FIG. 1 is a flowchart of some embodiments of a processing method for interactive multimedia content according to the present disclosure. As shown in FIG. 1, the method of this embodiment includes: steps S102 to S106.

In step S102, a content text of one or more side stories is generated according to a content text of an original story.

The original story may be input by a creative user. For example, a creative interface displaying the interactive multimedia content on a client is displayed, an input area is displayed in the creative interface, and the original story input by the creative user is received. The original story may be input as a whole, or input by chapters and in other forms, which will not be limited here.

The original story may also be one that has been published and used to generate the interactive multimedia content with the consent of the creative user. The original story may include a story line, and one or more story lines and a content text of each story line may be generated according to the story line of the original story.

In some embodiments, the original story includes a plurality of roles (characters), and a content text of one or more side stories is generated for each of the plurality of roles according to the content text of the original story. For a user viewing the interactive multimedia content, it is possible to select any of the plurality of roles and view (experience) a plot corresponding to the role.

For example, the content text of the one or more side stories is generated by using a generative model according to the content text of the original story. The generative model includes, for example, a model that generates content based on texts or based on images, and the output of the generative model may include a text, an image or a combination thereof. Of course, the input or output of the generative model may also be data of other modalities, for example, audio, video or a combination of multiple types of data. The generative model may be a single-modality model, for example, a model for generating a text based on a text (referred to as “Text to Text Model” for short) and a model for generating an image based on an image (referred to as “Image to Image Model” for short). Alternatively, the generative model may also be a cross-modal model, that is, the input and the output belong to different modalities, for example, a model for generating an image based on a text (referred to as “Text to Image Model” for short). Alternatively, the input of the generative model may include a plurality of modalities, and the output may also include a plurality of modalities.

In step S104, images are generated based on the content text of the original story and the content text of the one or more side stories.

For example, the images include an image of a character and an image of a scene. Since a character and a scene are basic constituent elements of each screen in the interactive multimedia content, each frame of image in the interactive multimedia content may be generated based on the image of the character and the image of the scene. For example, if the interactive multimedia content is an interactive story (an interactive novel), an interactive TV drama, an interactive movie or the like, the generated images may include an image of each frame of screen in the interactive multimedia content.

For example, the images are generated by using a generative model based on the content text of the original story and the content text of the one or more side stories.

In step S106, the interactive multimedia content is generated according to the content text of the original story, the content text of the one or more side stories and the images.

For example, the interactive multimedia content is generated by using the generative model according to the content text of the original story, the content text of the one or more side stories and the images. A genre of the interactive multimedia content may be set to generate the interactive multimedia content of the corresponding genre.

The above-described steps S102 to S106 may be performed by using the same generative model, for example, the content text of the original story is input into the generative model, and the interactive multimedia content is output.

In the method of the above-described embodiments, the content text of the one or more side stories is expanded based on the content text of the original story, and the images are generated to generate the interactive multimedia content according to the content text of the original story and the content text of the one or more side stories. By way of the method of the above-described embodiments, it is possible to expand into a whole content text of the interactive multimedia content only based on the content text of the original story and generate the interactive multimedia content, which improves the creation efficiency of the interactive multimedia content and saves the resource. An ordinary user may also participate in the creation and development of a story, so as to better interact with a role and create a story belonging to himself or herself, which improves the feasibility of a creation of the interactive multimedia content so that more ideas may be transformed into an interactive multimedia product.

In some embodiments, the processing method for interactive multimedia content further includes: displaying a main story of the original story and the one or more side stories, wherein the main story includes a plurality of main story-line nodes, and each of the one or more side stories includes a plurality of side story-line nodes.

The content of the original story may be understood by using a machine learning model, and the main story may be formed by extracting the plurality of the main story-line nodes of the original story. For example, it is possible to extract a plurality of key plots that affect a plot development of the original story, generate a summary of each key plot according to the content of each key plot, and generate each main story-line node; or generate each main story-line node according to brief description information such as a title of each key plot. The main story-line nodes are associated according to the development of the original story to generate the main story.

For example, the main story and the one or more side stories may be displayed in a form of a flowchart or the like. Connecting lines may be set between main story-line nodes which are associated with each other, between main story-line nodes and side story-line nodes which are associated with each other, and between side story-line nodes which are associated with each other, for connection according to a sequence of a plot development. By displaying the main story and the one or more side stories, it is possible to allow the creative user to determine a relationship between the generated one or more side stories and the main story more clearly and accurately, so as to facilitate the confirmation or adjustment.

In some embodiments, wherein the one or more side stories include one or more side stories corresponding to each of one or more characters, and the displaying a main story of the original story and the one or more side stories includes at least one of: displaying, for the each of one or more characters, the main story of the original story and the one or more side stories corresponding to the character; or displaying, in response to a selection operation of a first target character among the one or more characters, the main story of the original story and one or more side stories corresponding to the first target character.

One or more side stories corresponding to a plurality of characters may be displayed in the same interface or in different interfaces, which will not be limited here.

As shown in FIG. 2, for Character 1, a main story and a plurality of side stories are displayed, wherein the main story may take each chapter as a main story-line node, some main story-line nodes may derive side story-line nodes, and some main story-line nodes do not derive side story-line nodes. The main story corresponds to one ending, and the side stories and the main story correspond to different endings, and the endings corresponding to different side stories may be the same or different. The last main story-line node of the main story displays the corresponding ending information, and the last side story-line node of each side story displays the corresponding ending information. In response to a selection operation of other characters than Character 1 by the creative user, the main story and one or more side stories corresponding to other roles may be displayed.

In some embodiments, displaying, for each main story-line except a last main story-line node among the plurality of main story-line nodes, an identifier of a chapter corresponding to the main story-line node, and option information corresponding to the main story-line node in response to the main story-line node deriving a side story-line node; displaying ending information corresponding to the last main story-line node among the plurality of main story-line nodes; displaying, for each side story-line node except a last side story-line node among the plurality of side story-line nodes of the each of the one or more side stories, option information corresponding to the side story-line node, in response to the side story-line node being a side story-line node derived from another node or the side story-line node deriving another side story-line node, wherein the another node includes a main story-line node or a side story-line node other than the side story-line node; or displaying ending information corresponding to the last side story-line node among the plurality of side story-line nodes of the each of the one or more side stories.

For example, the identifier of the chapter is a chapter number or the like, and the option information corresponding to the main story-line node may be generated by the machine learning model according to the content of a chapter corresponding to the main story-line node. The option information corresponding to the main story-line node may be used to describe an option to perform an interactive operation provided to a viewing user before a chapter corresponding to the main story-line node starts. The main story-line node may derive a side story-line node, that is, the content of a side story-line node expanded based on the content of the main story-line node, and the side story-line node may also further derive another side story-line node. The option information corresponding to the main story-line node and its derived side story-line node is different selections made by a character in the story based on the same occurrence. The option information corresponding to the side story-line node and its derived side story-line node is different selections made by a character in the story based on the same occurrence. The ending information may include: at least one of a title of an ending chapter and a brief description (summary) of an ending, but is not limited to the listed examples.

As shown in FIG. 2, each main story-line node except the last main story-line node in the main story displays a chapter identifier corresponding to the main story-line node. Of course, the last main story-line node which may also display a corresponding chapter identifier, is not limited to only displaying the corresponding ending information. The main story-line node corresponding to a second chapter derivates a side story-line node, the main story-line node corresponding to the second chapter displays the corresponding option information “Go to Mars with B”, and the derived side story-line node displays the corresponding option information “Don't go to Mars with B”. Subsequent side story-line nodes may be further appended (expanded) based on the derived side story-line node. For example, the side story-line node corresponding to the ending information is further appended by following the derived side story-line node.

The information displayed by each node (a main story-line node or a side story-line node) which is not limited to the information shown in FIG. 2, may be configured according to actual needs, as long as the creative user may clearly and accurately understand a relationship and content between the nodes.

In some embodiments, a content text corresponding to each side story-line node may be expanded by using a generative model according to each side story-line node.

In response to a selection operation of a target node in nodes (main story-line nod or side story-line nod), the content text corresponding to the target node is displayed.

In some embodiments, in response to a modification operation on option information of a first target main story-line node among the plurality of main story-line nodes, the modified option information of the first target main story-line node and modified option information of a side story-line node derived from the first target main story-line node are displayed; and/or in response to a modification operation on a content text of a first target side story-line node among a plurality of side story-line nodes in the one or more side stories, a modified content text of the first target side story-line node is displayed.

The content text corresponding to each side story-line node may be expanded by using a generative model according to each side story-line node. The creative user may modify each side story-line node, the option information of each side story-line node and the content text corresponding to each side story-line node, and also modify the option information of the main story-line node. For example, in response to modifying the option information of the first target main story-line node, it is determined whether the option information of the side story-line node derived therefrom needs to be modified, and if so, each side story-line node following the side story-line node derived from the first target main story-line node is generated according to the modified option information of the side story-line node derived from the first target main story-line node. Further, it is determined whether the side story where the side story-line node derived from the first target main story-line node is situated needs to be modified. If so, each side story-line node following the side story-line node derived from the first target main story-line node on the side story is generated according to the modified option information of the side story-line node derived from the first target main story-line node. Furthermore, a content text of each side story-line node on the side story is also generated.

For example, in response to modifying the content text of the first target side story-line node, a modified content text of the first target side story-line node is generated, and according to the modified content text of the first target side story-line node, other side story-line nodes on the side story where the first target side story-line node is situated as well as the content texts of other side story-line nodes are generated. Each side story-line node on the side story where the modified first target side story-line node is situated may be displayed, and a content text of each side story-line node may also be displayed.

The creative user may also perform an operation such as deletion and addition on a side story-line node. In some embodiments, in response to a deletion operation on a second target side story-line node, the side story where the second target side story-line node is situated is deleted, or in response to a deletion operation on a target side story, the target side story is deleted. For example, in response to an operation of adding a side story-line node to a second target main story-line node, option information of the second target main story-line node and option information of the side story-line node derived from the second target main story-line node are generated according to the content of the second target main story-line node. According to the option information of the side story-line node derived from the second target main story-line node, a content text of the side story-line node is generated. Further, according to a content text of the side story-line node, the content texts of other side story-line nodes on the side story are appended.

In some embodiments, the generating a content text of one or more side stories according to a content text of an original story includes: determining one or more main story-line nodes in a main story of the original story according to the content text of the original story; deriving one or more side story-line nodes as one or more initial side story-line nodes according to each of the one or more main story-line nodes; and generating a plurality of side story-line nodes in a side story-line and expanding content of the plurality of side story-line nodes, according to each of the one or more initial side story-line nodes, to generate the content text of the one or more side stories.

For example, the one or more side stories and the content text of each side story are generated by using a generative model according to the content text of the original story.

In some embodiments, the one or more side stories include one or more side stories corresponding to each of one or more characters, and the determining one or more main story-line nodes in a main story of the original story according to the content text of the original story includes, for the each of one or more characters: selecting one or more key chapters associated with a story of the character and one or more key plots in each of the one or more key chapters from a plurality of chapters of the main story according to the content text of the original story; and generating one or more main story-line nodes associated with the character in the main story of the original story according to the one or more key plots in the each of the one or more key chapters.

For example, a generative model is used to understand the content of the original story and determine the main story, the one or more key chapters and the one or more key plots, and further generate a summary (brief description information) of each of the one or more main story-line nodes according to the content of the one or more key plots.

In some embodiments, the deriving one or more side story-line nodes as one or more initial side story-line nodes according to each of the one or more main story-line nodes includes: determining option information of the each of the one or more main story-line nodes according to a key plot corresponding to the each of the one or more main story-line nodes, wherein the option information is configured to describe a selection by a character associated with the each of the one or more main story-line nodes; and generating, for the each of the one or more main story-line nodes, one or more option information different from the option information of the main story-line node and one or more side story-line nodes corresponding to the one or more option information, according to the option information of the main story-line node.

For example, a generative model is used to understand the key plot corresponding to each main story-line node, and determine whether it is suitable to derive a side story-line node. If so, the option information of one or more side story-line nodes is generated according to the content of a chapter or a key plot corresponding to the each main story-line node.

In some embodiments, the expanding content of the plurality of side story-line nodes includes: expending, for each of the plurality of side story-line nodes, content of the side story-line according to a content text of at least one node in a main story-line node and a side story-line node before the side story-line node and information of a character in a side story to which the side story-line belongs, wherein the information of the character includes at least one of setting information of the character or relationship information between characters.

For example, the setting information of the character includes name, gender, age, personality, appearance, ability and the like, but is not limited to the listed examples. For example, for each side story-line node, the content of the side story-line node is expended by using a generative model according to the content text of at least one node in a main story-line node and a side story-line node before the side story-line node and information of a character in a side story to which the side story-line belongs.

In some embodiments, the processing method for interactive multimedia content further includes at least one of: displaying a description text of the character in the content text of the original story in an association with the image of the character; or displaying a description text of the scene in the content text of the original story in an association with the image of the scene.

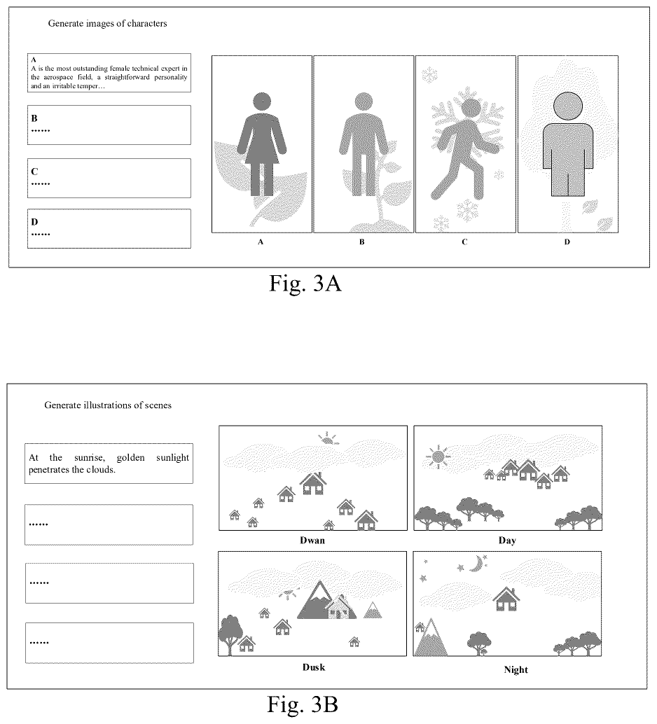

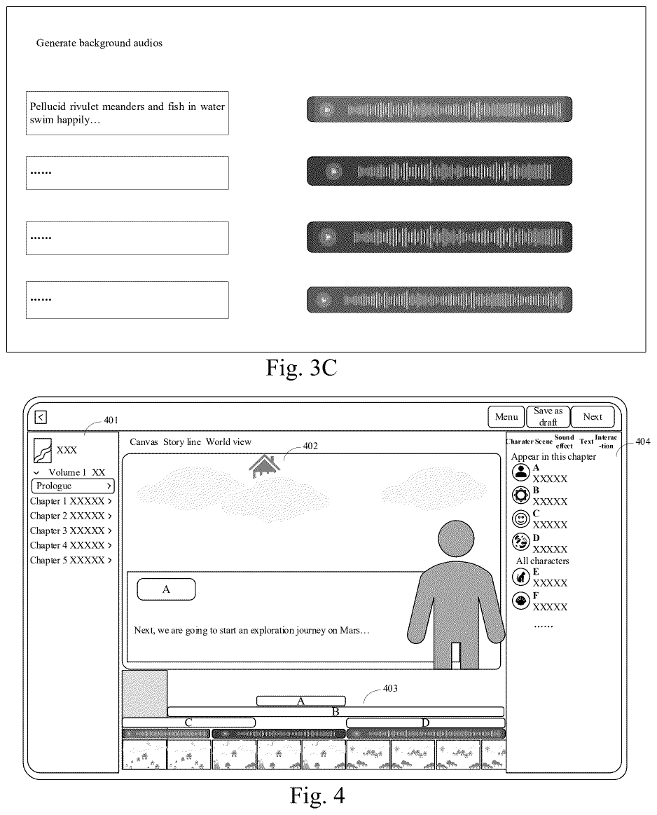

As shown in FIG. 3A, a description text of a character is displayed in association with an image of the character. The main characters in the original story and the side story include A, B, C and D, wherein a plurality of characters may be displayed in the same interface, or each character may also be displayed in one interface, which will not be limited here.

As shown in FIG. 3B, a description text of a scene is displayed in association with an image of a scene. The original story and the side story include a plurality of scenes, wherein a plurality of scenes may be displayed in the same interface, or each scene may be displayed in one interface, which will not be limited here.

In some embodiments, the character includes a plurality of characters and the scene includes a plurality of scenes, and the processing method further includes at least one of: regenerating and displaying an image of a second target character in response to an updating operation on an image of the second target character among the plurality of characters; displaying, for each of the plurality of characters, a plurality of images of the character, and determining a first target image as the image of the character in response to a selection operation of the first target image among the plurality of images of the character; regenerating and displaying an image of a first target scene in response to an updating operation on an image of the first target scene in the plurality of scenes; or displaying, for each of the plurality of scenes, a plurality of images of the scene, and determining a second target image as the image of the scene in response to a selection operation on the second target image among the plurality of images of the scene.

The creative user, who is not satisfied with an image of a character or an image of a scene, may trigger a regeneration of the image of the character or the image of the scene. For example, for each character, a regenerated control corresponding to the character may be set, and in response to a trigger operation on the regenerated control corresponding to the character, the image of the character may be regenerated. For each scene, a regenerated control corresponding to the scene may be set, and in response to a trigger operation on the regenerated control corresponding to the scene, the image of the scene may be regenerated. For each character or scene, a plurality of images may be generated and selected by the creative user.

The creative user may also modify description information of a character or a scene. An image of a character or a scene is regenerated in response to modifying the description information of the character or the scene. Controls for modifying a style, a specific part, clothing and the like of a character may be set. For example, for each character, an image of a target style is regenerated in response to modifying a style of the character to the target style. For example, a Chinoiserie style is modified into an anime style. For example, it is possible to modify a hairstyle, clothing, appearance and the like of a character by trigger a corresponding control, which will not be described in detail here. A control for modifying a style of a scene, a specific building within the scene and the like may be set, and an image of the scene may be regenerated in response to a triggering of the control, which will not be described in detail here.

In some embodiments, the generating images based on the content text of the original story and the content text of the one or more side stories includes: extracting a description text of each of a plurality of characters from the content text of the original story and the content text of the one or more side stories; generating an image of the each of the plurality of characters according to the description text of the each of the plurality of characters; extracting a description text of each of a plurality of scenes from the content text of the original story and the content text of the one or more side stories; and generating an image of the each of the plurality of scenes according to the description text of the each of the plurality of scenes.

For example, a generative model is used to extract the description text of each character from the original story and the content text of the one or more side stories, and generate the image of each character. For example, the generative model is used to extract the description text of each scene from the original story and the content text of one or more side stories, and generate the image of each scene.

In some embodiments, the image further includes a map, and the processing method for interactive multimedia content further includes: displaying the map; and displaying, in response to a selection operation on a target location in the map, an image of a scene corresponding to the target location in association with a description text of the scene corresponding to the target location.

In a case where the original story includes a description of a plurality of locations and an orientation relationship between the plurality of locations, it is possible to generate the map drawn according to the orientation relationship between the plurality of locations. The map may be displayed in association with a description text of the plurality of locations. For example, the plurality of locations in the map may set a corresponding selection control, and the image of the scene corresponding to the target location and the description text of the scene corresponding to the target location are displayed in response to a trigger operation on the selection control of the target location.

In some embodiments, a description text of a plurality of locations is extracted from the content text of the original story and a content text of the one or more side stories, wherein the description text of the plurality of locations comprises an orientation relationship between the plurality of locations.

For example, a generative model is used to identify and extract a description text of a location in the content text of the original story and the content text of the one or more side stories to generate the map.

In some embodiments, the processing method for interactive multimedia content further includes: generating audios according to the content text of the original story and the content text of the one or more side stories, wherein the audios comprise a sound audio of the character and a background sound audio of the scene, wherein the generating the interactive multimedia content according to the content text of the original story, the content text of the one or more side stories and the images comprises: generating the interactive multimedia content according to the content text of the original story, and the content text of the one or more side stories, the images and the audios.

The audio in the interactive multimedia content may also be automatically generated by using a generative model. For example, the background sound audio of the scene includes: background music, a sound audio of a character and an object in the background and the like.

In some embodiments, the generating audios according to the content text of the original story and the content text of the one or more side stories includes: extracting setting information of each of the plurality of characters from the content text of the original story and the content text of the one or more side stories; generating a sound audio of the each of the plurality of characters according to the setting information of the each of the plurality of characters; extracting a description text of each of the plurality of scenes from the content text of the original story and the content text of the one or more side stories, and determining a story style; and generating a background sound audio of the each of the plurality of scenes according to the description text of the each of the plurality of scenes and the story style.

The feature of the audio of each character such as timbre and tone may reflect the setting information of the character such as gender, age and personality. Therefore, the setting information of each character may be extracted by using a generative model, and the sound audio of each character may be generated according to the setting information of each character. A sample of the sound audio of each character may be first generated, and for each character, an audio of a line of the character may be then generated according to the content of a line of the character. The content of the line may affect an emotion of the character, so as to affect the feature such as timbre, tone, loudness and speech speed. Therefore, for the audio of the line of each character, it is necessary to generate the corresponding audio according to the content of the line.

According to a description of a sound in a scene, the sound effects or music materials in different scenes may be generated as an audio of a background sound (for example, in a restaurant, the background music should be boisterous but cheerful, and when entering a combat, the background music is tense and impassioned).

The background sound audio of each scene may be generated only according to the description text of each scene. The story style may also affect a style of the background music. For example, if the story style is a Chinoiserie style, a background music of a Chinoiserie style may be generated. In addition to the background music, different scenes may also include some sounds of a character or an object, for example, the hawking of a character, the sound of an automobile and the like in the background. The audio of the background sound such as the background music and the sounds of the character and the object may be generated by using the generative model according to the description text of the scene.

In some embodiments, the character comprises a plurality of characters and the scene comprises a plurality of scenes, and the processing method for interactive multimedia content further includes at least one of: displaying sound audios of the plurality of characters in association with description texts of the plurality of characters, and playing a first target audio in response to a selection operation on the first target audio in the sound audios of the plurality of characters; or displaying background sound audios of the plurality of scenes in association with description texts of the plurality of scenes, and playing a second target audio in response to a selection operation on the second target audio in the background sound audios of the plurality of scenes.

For each character, the character may be displayed in association with the sound audio of the character, or the setting information of the character may be displayed in association with the sound audio of the character, or a description text of the character may be displayed in association with a sound audio of the character, which is not limited to the listed examples. For each character, the plurality of generated sound audios of the character may be displayed, and a sound audio of the character is determined in response to a confirmation operation on a certain audio among the plurality of sound audios.

As shown in FIG. 3C, the description text of each scene is displayed in association with the background sound audio, and the creative user may play the audio by clicking or the like.

In some embodiments, the sound audio of the character or the background sound audio of the scene is regenerated in response to a regeneration or modification operation on the sound audio of the character or the background sound audio of the scene.

If the creative user is not satisfied with a generated audio, the audio may be regenerated. A control for modifying a style of audio or the like may be set to modify the generated audio. An audio library and an audio selection control may be set, and a plurality of selected audios may be displayed in response to a triggering of the audio selection control, and an audio is taken as a background music of a current scene in response to a confirmation the certain audio.

The creative user may also upload an audio by himself or herself, which serves as a sound audio of a character or a background sound audio of a scene. For example, if the creative user uploads a sound audio of a certain character, an audio of a line of the character will be subsequently generated according to the sound audio of the character.

In each of the above-described embodiments, the one or more side stories may be automatically generated based on the original story, so that a storyboard with multiple endings may be generated, and the complete story content may be further generated based on a text content of the storyboard. In addition, the image and the audio of the character and the image and the audio of the scene may be automatically generated based on the content text of the original story and the one or more side stories. Finally, the interactive multimedia content is generated based on the content text, the image and the audio of the original story and the one or more side stories, which improves the generation efficiency of the interactive multimedia content.

During the process of generating the interactive multimedia content, the images and the audios of the one or more side stories, the character and the scene may be displayed, and the creative user may adjust and modify them, incorporate more own ideas, and create a story belonging to himself or herself, which improves a feasible and flexible creation of the interactive multimedia content.

After the interactive multimedia content is generated, a preview interface of the interactive multimedia content may be displayed for an operation such as preview or modification by the creative user, for example, the preview interface of the interactive multimedia content may be displayed in a production tool of the interactive multimedia content.

In some embodiments, a preview interface of the interactive multimedia content is displayed, wherein the preview interface comprises a control corresponding to each of a plurality of chapters of the interactive multimedia content; and a preview interface corresponding to a target chapter is displayed in response to a trigger operation on a control of the target chapter in the plurality of chapters.

For example, the preview interface corresponding to the target chapter includes: at least one of a screen of the target chapter, an image of a character, an image of a scene or an audio. An audio corresponding to a current page in the preview interface may be displayed whilst displaying the preview interface.

As shown in FIG. 4, the preview interface of the interactive multimedia content includes a first selection area 401, a main display area 402, a time sequence display area 403 and a second selection area 404. The first selection area 401 may be used to display a control of each chapter, a title of each chapter, or a summary (profile) of each chapter and the like. In FIG. 4, “XXXX” is used to indicate that a text may be displayed.

In response to a selection operation on the target chapter, a screen of the interactive multimedia content is displayed in the main display area 402, as shown in FIG. 4. For example, the screen of the interactive multimedia content includes: an image and a text of a character and a screen or the like. The screen of the interactive multimedia content may be a screen presented to a viewing user when the interactive multimedia content is played. One chapter may include multiple screens, which may be switched in display in response to a trigger operation on a switching control or in response to a preset switching operation.

As shown in FIG. 4, the time sequence display area 403 includes multiple tracks corresponding to characters, audios and images of scenes respectively. According to a displayed time sequence, display bars of the characters, display bars of the audios and the images of scenes are displayed in corresponding tracks. As shown in FIG. 4, the currently displayed screen is an image of a first scene, a character C and a first audio clip (a sound audio of a character or an audio of a background sound). In response to a first selection operation (which may serve as a preset switching operation) on a display bar of a character, a display bar of an audio or an image of a scene, a switched screen is displayed. For example, the creative user may click on images of different scenes, so as to display a screen corresponding to the clicked image of the scene. For another example, the creative user may click on a display bar of a character or different positions of a display bar of a character to display a corresponding screen.

For example, in response to a second selection operation on a display bar of a character, a display bar of an audio or an image of a scene, a modification interface of the character, a modification interface of the audio or a modification interface of the scene is displayed. It is possible to modify (or regenerate) an image, descriptive information and the like of the character, modify (or regenerate) the audio, or modify (or regenerate) the image of the screen, which will not be described in detail here.

As shown in FIG. 4, the main display area 402 may also include a plurality of option controls, such as a canvas control, a story line control and a world view control. In response to a triggering of the canvas control, a screen of the interactive multimedia content is displayed. In response to a triggering of the storyline control, a storyline (including the main story and the one or more side stories) corresponding to one or more characters is displayed. For example, the main story and the side stories corresponding to different characters shown in FIG. 2 may be displayed. In response to a triggering of the worldview control, a map is displayed. For a specific display method of the map, reference may be made to the aforementioned embodiments, which will not be described in detail here.

In some embodiments, the processing method for interactive multimedia content further includes: displaying one or more controls of one or more characters, wherein the one or more characters comprise one or more characters appearing in the target chapter, or the one or more characters comprise one or more characters in the interactive multimedia content; and displaying a details interface of a third target character in response to a trigger operation on a control of the third target character among the one or more characters, wherein the details interface comprises at least one of setting information, an image, character relationship information, a sound audio, appearance chapter information or ability information of the third target character. The setting information, the image, the character relationship information, the sound audio, the appearance chapter information and the ability information of the third target character may be displayed in the same page or in different pages, which will not be limited here.

As shown in FIG. 4, the second selection area 404 includes a plurality of option controls, for example, a character option control, a scene option control, a sound effect option control, a text option control and an interactive option control. In response to a triggering of the character option control, one or more controls of one or more characters are displayed. As shown in FIG. 4, a control of a character in the current chapter may be displayed differently from controls of other characters. For each character, an avatar, a name and brief description information of the character may be displayed. In response to a triggering of the control of the third target character, the details interface of the third target character is displayed.

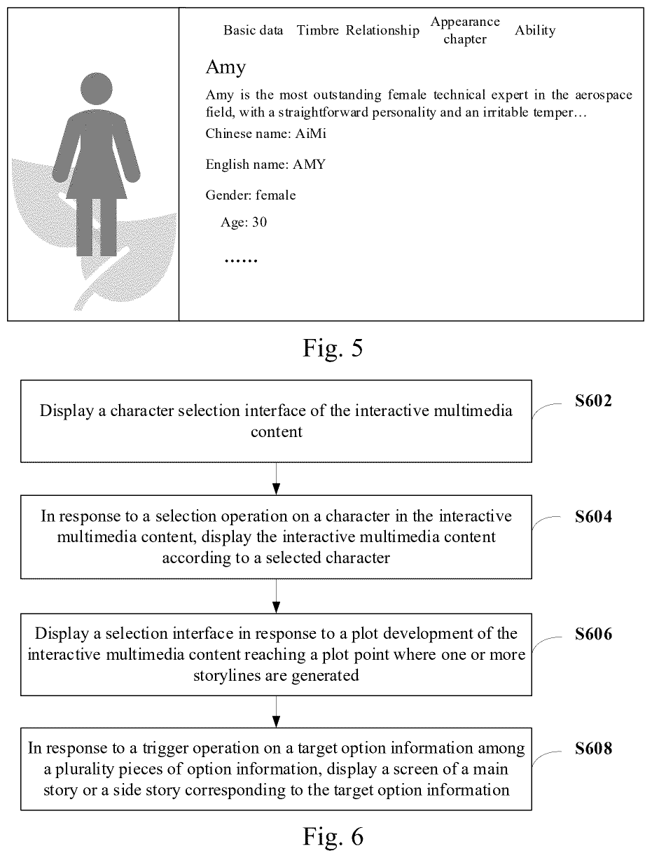

As shown in FIG. 5, for any character, the details interface of the character includes an image of the character, and may also include multiple option controls, such as a basic data control, a timbre control, a character relationship control, an appearance chapter control and an ability control. In response to a triggering of the basic data control, the setting information of the character, such as name, gender, age, personality, appearance and life experience, is displayed, which is not limited to the listed examples. In response to a triggering of the timbre control, a sound audio of the character is displayed and the sound audio of the character is played. In response to a triggering of the character relationship control, a relationship between the character and other characters may be displayed, for example, in the form of a network diagram, a topology diagram, a text and the like, which is not limited to the listed examples. In response to a triggering of the appearance chapter control, an appearance chapter of the character is displayed, for example, information such as a title and an abstract of the chapter may also be displayed. In response to a triggering of the ability control, the ability information of the character is displayed, for example, the information of a weapon in use, skill information and the like, which is not limited to the listed examples.

In some embodiments, the processing method for interactive multimedia content further includes: displaying one or more control of one or more scenes, wherein the one or more scenes comprise one or more scenes in the target chapter or the one or more scenes comprise one or more scenes in the interactive multimedia content; and displaying an image of a second target scene in response to a trigger operation on a control of the second target scene in the one or more scenes.

As shown in FIG. 4, the second selection area 404 displays a scene option control. In response to a triggering of the scene option control, one or more control of one or more scenes are displayed. For example, a control of a scene may be displayed with a thumbnail of a scene, and a name, brief description information and the like of the scene may also be displayed. A control of a scene in a current chapter may be displayed differently from controls of other scenes. In response to the trigger operation on a control of the second target scene, the main display area displays the image of the second target scene or a screen containing the interactive multimedia content of the second target scene.

In some embodiments, the processing method for interactive multimedia content further includes: displaying a control of one or more audios, wherein the one or more audios comprise one or more audios in the target chapter or the one or more scenes comprise one or more audios in the interactive multimedia content; and playing the third target audio in response to a trigger operation on a control of a third target audio in the one or more audios.

As shown in FIG. 4, the second selection area 404 displays an audio option control. In response to a triggering of the audio option control, one or more audio controls are displayed, and keywords, brief description information and the like of audios may also be displayed. A control of an audio in the current chapter may be displayed differently from controls of other audios. In response to a trigger operation on the control of the third target audio, the third target audio is played, and the main display area 404 may display a screen of the interactive multimedia content corresponding to the third target audio.

In some embodiments, the preview interface corresponding to the target chapter comprises an image of a character in the target chapter, an image of a scene in the target chapter and a text in the target chapter, and the processing method for interactive multimedia content further includes: displaying an edited text in response to an editing operation on the text.

As shown in FIG. 4, the main display area 402 displays a text, such as a line of a character and description information of a scene, and an edited text is displayed in response to an editing operation on a text. The creative user may edit and modify a content text such as the line of the character and the description text of the scene.

As shown in FIG. 4, the second selection area 404 displays a text option control. In response to a triggering of the text option control, one or more text controls are displayed. A control of a text in the current chapter may be displayed differently from controls of other texts. In response to a trigger operation on a control of a target text, the main display area 404 may display a screen of the interactive multimedia content corresponding to the target text.

As shown in FIG. 4, the second selection area 404 displays an interactive option control. In response to a triggering of the interactive option control, one or more interactive controls are displayed. An interactive control in the current chapter may be displayed differently from other interactive controls. In response to a trigger operation on a control of a target interaction, the main display area 404 may display a screen of the interactive multimedia content corresponding to the target interaction, which may display a plurality of options required to be selected by a viewing user or an operation required to be made by a viewing user.

The second selection area 404 may also display an animation option control. In response to a triggering of the animation option control, one or more controls of one or more animations is displayed. A control of an animation in the current chapter may be displayed differently from controls of other animations. In response to a trigger operation on a control of a target animation, the main display area 404 may display the target animation. The interactive multimedia content may include some animations which may be previewed.

In the second selection area, the display forms such as a control of a character, a control of a scene, a control of an audio, a control of a text and an interactive control are not limited, as long as different controls may be distinguished and an identification effect may be produced.

In the method of the above-described embodiments, after generating the content text, images and audios of the interactive multimedia content, it is possible to generate the interactive multimedia content or a sample of the interactive multimedia content, and display a preview interface of the interactive multimedia content, which is convenient for the creative user to adjust various details such as the story architecture, the story line, the text, the images and the audios so as to generate accurate and appropriate interactive multimedia content.

Some embodiments of the operation process after the interactive multimedia content is generated will be described below in conjunction with FIG. 6.

FIG. 6 is a flowchart of other embodiments of a processing method for interactive multimedia content according to the present disclosure. As shown in FIG. 6, the method of this embodiment includes: steps S602 to S608.

In step S602, a character selection interface of the interactive multimedia content is displayed.

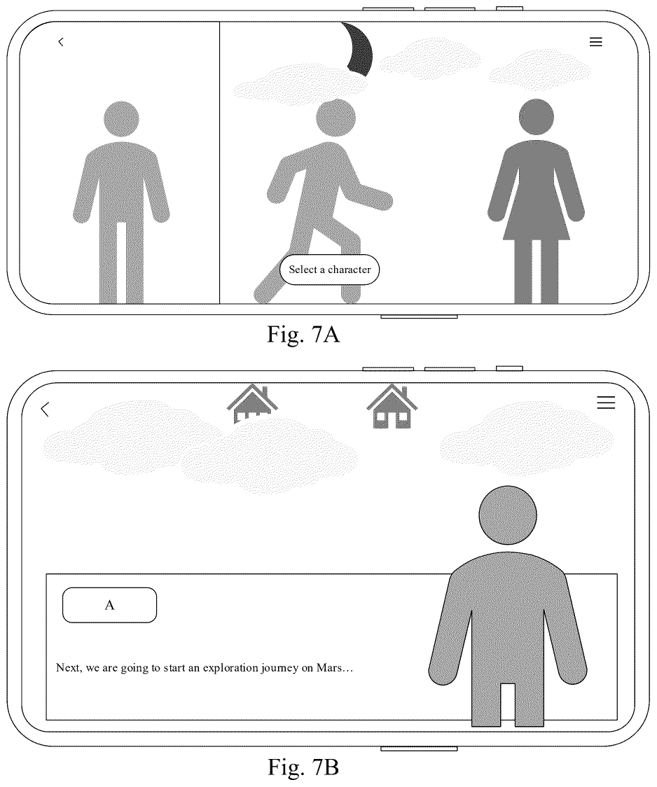

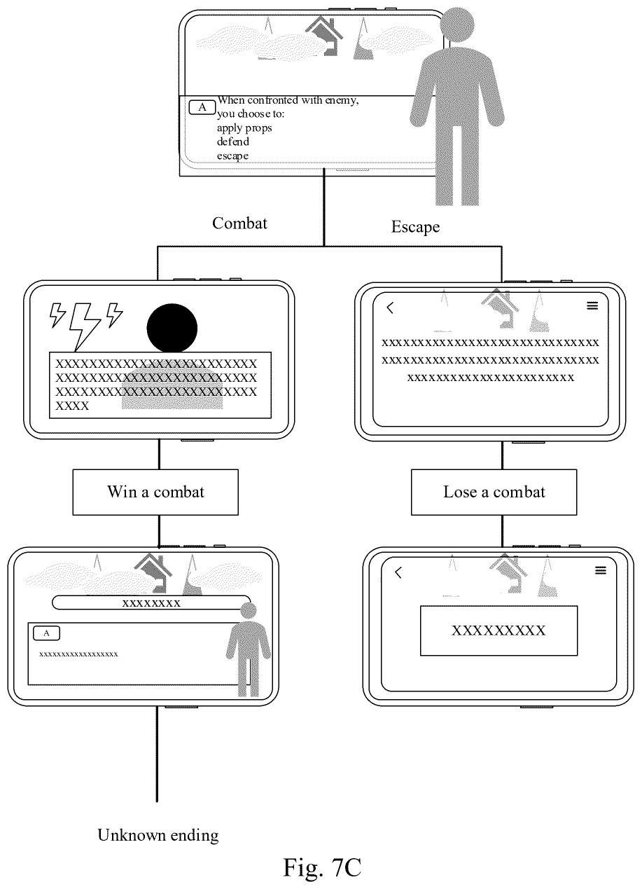

For example, in response to a starting operation on the interactive multimedia content, the character selection interface of the interactive multimedia content is displayed, wherein the character selection interface may include images of a plurality of characters, and may also include at least one of names or description information, which is not limited to the listed examples. As shown in FIG. 7A, the character selection interface includes images of a plurality of characters, and may include a selection control.

In step S604, in response to a selection operation on a character in the interactive multimedia content, the interactive multimedia content is displayed according to a selected character.

For example, in response to a triggering of the selection control, a plurality of character options are displayed, and in response to a trigger operation on a target character option (i.e., a selection operation of a character), a selected character is determined. Since different characters may correspond to different side stories, that is, the content corresponding to different side stories in the interactive multimedia content may be displayed for different characters. After a viewing user of the interactive multimedia content selects a character (role), a story from a perspective of this character is generated, so that the viewing user may experience a completely different story from other characters.

As shown in FIG. 7B, the screen of the interactive multimedia content is presented in the form of a scene, a character dialogue, a voice-over or a character conversation, which allows more fun in text reading.

In step S606, a selection interface is displayed in response to a plot development of the interactive multimedia content reaching a plot point where one or more storylines are generated.

For example, the selection interface includes a plurality pieces of option information. The plurality pieces of option information is the option information of main story-line nodes on the main story and the option information of a derived side story-line node.

In step S608, in response to a trigger operation on a target option information among a plurality pieces of option information, a screen of a main story or a side story corresponding to the target option information is displayed.

If the target option information is the option information corresponding to a main story-line node, a screen of the main story corresponding to the target option information is displayed; and if the target option information is the option information corresponding to a side story-line node, a screen of a side story corresponding to the target option information is displayed.

Steps S606 to S608 may be replaced by displaying a selection interface in response to a plot development of the interactive multimedia content reaching a plot point where the one or more storylines are generated; receiving input selection information; identifying the selection information and determining a side story corresponding to the selection information; and displaying a screen of the side story corresponding to the selection information. The viewing user may select a following plot by inputting the selection information. The selection information may be identified and understood by using a machine learning model so as to match a side story related to the selection information.

As shown in FIG. 7C, the selection interface may include operations required to be selected by a viewing user, for example, “apply props”, “defend” and “escape”. If the viewing user selects different options, a plot on different side stories may be triggered.

Based on the method of the above-described embodiments, when the interactive multimedia content is displayed, the screen content is more abundant and more interactive, thereby enhancing the reading experience of the user.

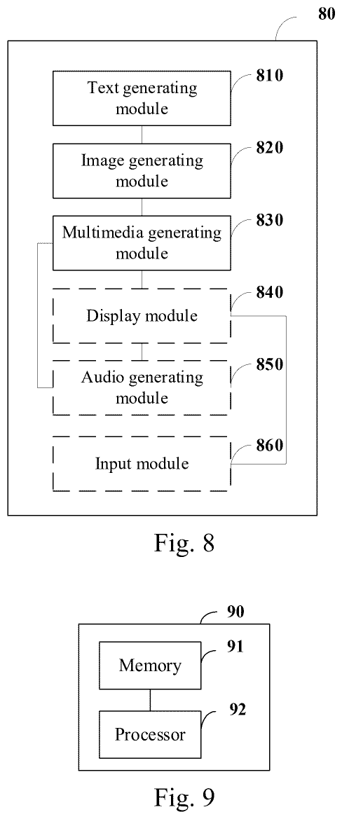

The present disclosure also provides an interactive multimedia content processing apparatus, which will be described below in conjunction with FIG. 8.

FIG. 8 is a structural view of some embodiments of a processing apparatus for interactive multimedia content according to the present disclosure. As shown in FIG. 8, the processing apparatus 80 of this embodiment includes: a text generating module 810, an image generating module 820 and a multimedia generating module 830.

The text generating module 810 is configured to generate a content text of one or more side stories according to a content text of an original story.

The image generating module 820 is configured to generate images based on the content text of the original story and the content text of the one or more side stories, wherein the images comprise an image of a character and an image of a scene.

The multimedia generating module 830 is configured to generate the interactive multimedia content according to the content text of the original story, the content text of the one or more side stories and the images.

In some embodiments, the processing apparatus 80 further includes: a display module 840 configured to display a main story of the original story and the one or more side stories, wherein the main story comprises a plurality of main story-line nodes, and each of the one or more side stories comprises a plurality of side story-line nodes.

In some embodiments, the one or more side stories comprise one or more side stories corresponding to each of one or more characters, and the display module 840 is configured to perform at least one of: displaying, for the each of one or more characters, the main story of the original story and the one or more side stories corresponding to the character; or displaying, in response to a selection operation of a first target character among the one or more characters, the main story of the original story and one or more side stories corresponding to the first target character.

In some embodiments, the display module 840 is configured to perform at least one of: displaying, for each main story-line except a last main story-line node among the plurality of main story-line nodes, an identifier of a chapter corresponding to the main story-line node, and option information corresponding to the main story-line node in response to the main story-line node deriving a side story-line node; displaying ending information corresponding to the last main story-line node among the plurality of main story-line nodes; displaying, for each side story-line node except a last side story-line node among the plurality of side story-line nodes of the each of the one or more side stories, option information corresponding to the side story-line node, in response to the side story-line node being a side story-line node derived from another node or the side story-line node deriving another side story-line node, wherein the another node comprises a main story-line node or a side story-line node other than the side story-line node; or displaying ending information corresponding to the last side story-line node among the plurality of side story-line nodes of the each of the one or more side stories.

In some embodiments, the display module 840 is configured to perform at least one of: displaying, in response to a modification operation on option information of a first target main story-line node among the plurality of main story-line nodes, the modified option information of the first target main story-line node and modified option information of a side story-line node derived from the first target main story-line node; or displaying, in response to a modification operation on a content text of a first target side story-line node among a plurality of side story-line nodes in the one or more side stories, a modified content text of the first target side story-line node.

In some embodiments, the text generating module 810 is configured to determining one or more main story-line nodes in a main story of the original story according to the content text of the original story; deriving one or more side story-line nodes as one or more initial side story-line nodes according to each of the one or more main story-line nodes; and generating a plurality of side story-line nodes in a side story-line and expanding content of the plurality of side story-line nodes, according to each of the one or more initial side story-line nodes, to generate the content text of the one or more side stories.

In some embodiments, the one or more side stories comprise one or more side stories corresponding to each of one or more characters, and the text generating module 810 is configured to, for the each of one or more characters: select one or more key chapters associated with a story of the character and one or more key plots in each of the one or more key chapters from a plurality of chapters of the main story according to the content text of the original story; and generate one or more main story-line nodes associated with the character in the main story of the original story according to the one or more key plots in the each of the one or more key chapters.

In some embodiments, the text generating module 810 is configured to determine option information of the each of the one or more main story-line nodes according to a key plot corresponding to the each of the one or more main story-line nodes, wherein the option information is configured to describe a selection by a character associated with the each of the one or more main story-line nodes; and generate, for the each of the one or more main story-line nodes, one or more option information different from the option information of the main story-line node and one or more side story-line nodes corresponding to the one or more option information, according to the option information of the main story-line node.

In some embodiments, the text generating module 810 is configured to expend, for each of the plurality of side story-line nodes, content of the side story-line according to a content text of at least one node in a main story-line node and a side story-line node before the side story-line node and information of a character in a side story to which the side story-line belongs, wherein the information of the character comprises at least one of setting information of the character or relationship information between characters.

In some embodiments, the display module 840 is also configured to perform at least one of: displaying a description text of the character in the content text of the original story in an association with the image of the character; or displaying a description text of the scene in the content text of the original story in an association with the image of the scene.

In some embodiments, the character comprises a plurality of characters and the scene comprises a plurality of scenes, and the image generating module 820 is further configured to perform at least one of: regenerating and displaying an image of a second target character in response to an updating operation on an image of the second target character among the plurality of characters; displaying, for each of the plurality of characters, a plurality of images of the character, and determining a first target image as the image of the character in response to a selection operation of the first target image among the plurality of images of the character; regenerating and displaying an image of a first target scene in response to an updating operation on an image of the first target scene in the plurality of scenes; or displaying, for each of the plurality of scenes, a plurality of images of the scene, and determining a second target image as the image of the scene in response to a selection operation on the second target image among the plurality of images of the scene.

In some embodiments, the image generating module 820 is configured to extract a description text of each of a plurality of characters from the content text of the original story and the content text of the one or more side stories; generate an image of the each of the plurality of characters according to the description text of the each of the plurality of characters; extract a description text of each of a plurality of scenes from the content text of the original story and the content text of the one or more side stories; and generate an image of the each of the plurality of scenes according to the description text of the each of the plurality of scenes.

In some embodiments, the image further includes a map, and the display module 840 is further configured to display the map; and display, in response to a selection operation on a target location in the map, an image of a scene corresponding to the target location in association with a description text of the scene corresponding to the target location.

In some embodiments, the image further includes a map, and the image generating module 820 is further configured to extract a description text of a plurality of locations from the content text of the original story and a content text of the one or more side stories, wherein the description text of the plurality of locations comprises an orientation relationship between the plurality of locations; and generate the map according to the description text of the plurality of locations.

In some embodiments, the processing apparatus further includes: an audio generating module 850 configured to generate audios according to the content text of the original story and the content text of the one or more side stories, wherein the audios comprise a sound audio of the character and a background sound audio of the scene, and the multimedia generating module 830 is configured to generate the interactive multimedia content according to the content text of the original story, and the content text of the one or more side stories, the images and the audios.

In some embodiments, the characters are plural and the scenes are plural, and the display module 840 is configured to perform at least one of: displaying sound audios of the plurality of characters in association with description texts of the plurality of characters, and playing a first target audio in response to a selection operation on the first target audio in the sound audios of the plurality of characters; or displaying background sound audios of the plurality of scenes in association with description texts of the plurality of scenes, and playing a second target audio in response to a selection operation on the second target audio in the background sound audios of the plurality of scenes.

In some embodiments, the audio generating module 850 is configured to extract setting information of each of the plurality of characters from the content text of the original story and the content text of the one or more side stories; generate a sound audio of the each of the plurality of characters according to the setting information of the each of the plurality of characters; extract a description text of each of the plurality of scenes from the content text of the original story and the content text of the one or more side stories, and determining a story style; and generate a background sound audio of the each of the plurality of scenes according to the description text of the each of the plurality of scenes and the story style.

In some embodiments, the display module 840 is configured to display a preview interface of the interactive multimedia content, wherein the preview interface comprises a control corresponding to each of a plurality of chapters of the interactive multimedia content; and display a preview interface corresponding to a target chapter in response to a trigger operation on a control of the target chapter in the plurality of chapters.

In some embodiments, the display module 840 is configured to display one or more controls of one or more characters, wherein the one or more characters comprise one or more characters appearing in the target chapter, or the one or more characters comprise one or more characters in the interactive multimedia content; and display a details interface of a third target character in response to a trigger operation on a control of the third target character among the one or more characters, wherein the details interface comprises at least one of setting information, an image, character relationship information, a sound audio, appearance chapter information or ability information of the third target character.

In some embodiments, the display module 840 is configured to display one or more control of one or more scenes, wherein the one or more scenes comprise one or more scenes in the target chapter or the one or more scenes comprise one or more scenes in the interactive multimedia content; and display an image of a second target scene in response to a trigger operation on a control of the second target scene in the one or more scenes.

In some embodiments, the display module 840 is configured to display a control of one or more audios, wherein the one or more audios comprise one or more audios in the target chapter or the one or more scenes comprise one or more audios in the interactive multimedia content; and play the third target audio in response to a trigger operation on a control of a third target audio in the one or more audios.

In some embodiments, the preview interface corresponding to the target chapter comprises an image of a character in the target chapter, an image of a scene in the target chapter and a text in the target chapter, and the display module 840 is configured to display an edited text in response to an editing operation on the text.

The processing apparatus 80 further includes: a display module 840 further configured to display a character selection interface of the interactive multimedia content; and display the interactive multimedia content according to a selected character in response to a selection operation on a character in the interactive multimedia content.

In some embodiments, the display module 840 is further configured to display a selection interface in response to a plot development of the interactive multimedia content reaching a plot point where the one or more side stories are generated, wherein the selection interface comprises a plurality pieces of option information; and display a screen of the main story or a side story corresponding to a target option information in response to a trigger operation on the target option information among the plurality pieces of option information.

In some embodiments, the display module 840 is further configured to display a selection interface in response to a plot development of the interactive multimedia content reaching a plot point where the one or more storylines are generated; the processing apparatus 80 further includes: an input module 860 configured to receive the input selection information; identify the selection information and determining a side story corresponding to the selection information; and the display module 840 further is configured to display a screen of the side story corresponding to the selection information.

The above-described functions of displaying the character selection interface, the selection interface and the like on a viewing user side may also be realized by other devices or clients.

It should be noted that, the above-described units (modules) are only logical modules divided according to the specific functions realized by the same, but not intended to limit specific implementations. For example, it is possible to be implemented in the form of software, hardware, or a combination of software and hardware. In actual implementation, the above-described respective units may be implemented as an independent physical entity, or may also be implemented by a single entity (for example, a processor (CPU or DSP, etc.), an integrated circuit, and the like). In addition, the above-described respective units are shown with dotted lines in the accompanying drawings to indicate that these units may not actually exist, and the operations/functions realized by them may be implemented by the processing circuit itself.

In addition, although not shown, the device may also include a memory, which may store various information generated by the device and various units included in the device during operation, programs and data for operation, data to be sent by the communication unit, and the like. The memory may be a volatile memory and/or a non-volatile memory. For example, the memory may include, but is not limited to, a random access memory (RAM), a dynamic random access memory (DRAM), a static random access memory (SRAM), a read only memory (ROM), and a flash memory. Of course, the memory may also be located outside the device. Alternatively, although not shown, the device may also include a communication unit, which may be used to communicate with other devices. In one example, the communication unit may be implemented in an appropriate manner known in the art, for example, including communication components such as antenna arrays and/or radio frequency links, various types of interfaces, communication units, and the like, which will not be described in detail here. Detailed description will not be repeated here. In addition, the device may also include other components not shown, such as a radio frequency link, a baseband processing unit, a network interface, a processor, a controller, and the like, which will not be described in detail here. Detailed description will not be repeated here.

In some embodiments of the present disclosure, an electronic device is also provided. FIG. 9 shows a block view of the electronic device according to some embodiments of the present disclosure. For example, in some embodiments, the electronic device 90 which may be various types of devices, for example may include, but is not limited to mobile terminals such as mobile phones, notebook computers, digital broadcast receivers, PDAs (personal digital assistants), PADs (pad computers), PMP (Portable Multimedia Player) and in-vehicle terminals (for example, in-vehicle navigation terminals); and fixed terminals such as digital TVs, desktop computers and the like. For example, the electronic device 90 may include a display panel for displaying data and/or execution results used in the solution according to the present disclosure. For example, the display panel may have various shapes, such as a rectangular panel, an oval panel, or a polygonal panel. In addition, the display panel may be not only a flat panel, but also a curved panel, or even a spherical panel.

As shown in FIG. 9, the electronic device 90 of this embodiment includes: a memory 91, and a processor 92 coupled to the memory 91. It should be noted that the components of the electronic device 90 shown in FIG. 9 are only exemplary, but not restrictive. According to actual application requirements, the electronic device 90 may also have other components. The processor 92 may control other components in the electronic device 90 to perform desired functions.

In some embodiments, the memory 91 is configured to store one or more computer-readable instructions. When the processor 92 is configured to run computer-readable instructions, the computer-readable instructions are executed by the processor 92 to implement the method according to any of the above-described embodiments. For the specific implementation of each step of the method and the related content as explained, it is possible to refer to the above-described embodiments, which will not be described in detail here.

For example, the processor 92 and the memory 91 may directly or indirectly communicate with each other. For example, the processor 92 and the memory 91 may communicate through a network. The network may include a wireless network, a wired network, and/or any combination of a wireless network and a wired network. The processor 92 and the memory 91 may also communicate with each other through a system bus, which is not limited in the present disclosure.

For example, the processor 92 may be embodied as various appropriate processors, processing apparatus and the like, such as a central processing unit (CPU), a graphics processing unit (GPU) and a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may be X86 or ARM architecture and the like. For example, the memory 91 may include any combination of various forms of computer-readable storage media, such as a volatile memory and/or a non-volatile memory. The memory 51 may include, for example, a system memory. The memory 91 may include, for example, a system memory. The system memory, for example, stores an operating system, an application program, a boot loader, a database, and other programs. Various application programs and various data may also be stored in the storage medium.

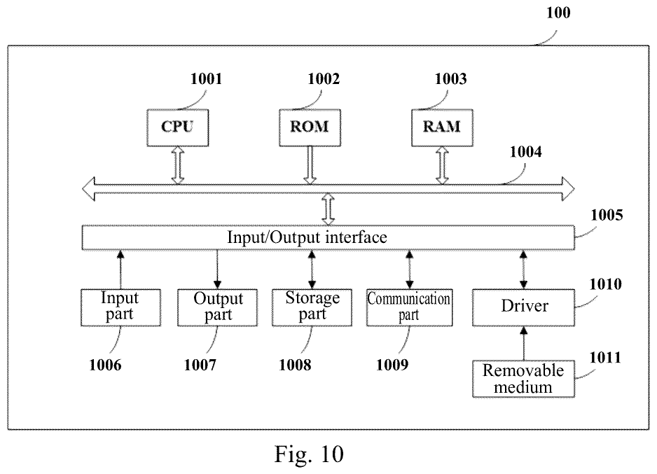

In addition, according to some embodiments of the present disclosure, in the case where various operations/processes according to the present disclosure are implemented by software and/or firmware, it is possible to install a program constituting the software to a computer system with a dedicated hardware structure, for example, the computer system (or the electronic device) 100 shown in FIG. 10, from a storage medium or a network. When the computer system is installed with various programs, it is possible to perform various functions, including the functions described previously. FIG. 10 is a block view showing an example structure of a computer system that may be employed in an embodiment of the present disclosure.

In FIG. 10, a central processing unit (CPU) 1001 executes various processes according to a program stored in a read only memory (ROM) 1002 or a program loaded from a storage part 1008 to a random access memory (RAM) 1003. In the RAM 1003, data required when the CPU 1001 executes various processes and the like is also stored as necessary. The central processing unit which is only exemplary, may also be other types of processors, such as the processors described above. The ROM 1002, the RAM 1003, and the storage part 1008 may be various forms of computer-readable storage media, as described below. It should be noted that although the ROM 1002, the RAM 1003, and the storage part 1008 are shown in FIG. 10 respectively, one or more of them may be combined or located in the same or different memories or storage modules.

The CPU 1001, the ROM 1002, and the RAM 1003 are connected to each other via a bus 1004. The input/output interface 1005 is also connected to the bus 1004.

The following components are connected to the input/output interface 1005: an input part 1006, such as a touch screen, a touch panel, a keyboard, a mouse, an image sensor, a microphone, an accelerometer and gyroscope; an output part 1007, including a display, such as a cathode ray tube (CRT), a liquid crystal display (LCD), a speaker, and a vibrator; a storage part 1008, including a hard disk, and a tape; and a communication part 1009, including a network interface card such as a LAN card and a modem. The communication part 1009 allows execution of communication processing via a network such as Internet. It is easily conceivable that, although the devices or modules in the computer system 100 shown in FIG. 10 communicate through the bus 1004, it is possible to also communicate through a network or other means, wherein the network may include a wireless network, a wired network, and/or any combination of a wireless network and a wired network.

The driver 1010 is also connected to the input/output interface 1005 as required. A removable medium 1011 such as a magnetic disk, an optical disk, a magneto-optical disk and a semiconductor memory is mounted on the driver 1010 as necessary, so that the computer program read out therefrom is installed into the storage part 1008 as necessary.

In a case of implementing the above-described series of processes by software, the program constituting a software may be installed from a network such as Internet or a storage medium such as a removable medium 1011.

According to the embodiment of the present disclosure, the process described above in conjunction with the flowchart may be implemented as a computer software program. For example, the embodiment of the present disclosure includes a computer program product including a computer program carried on a computer-readable medium, wherein the computer program contains program codes for performing the method shown in the flowchart. In such embodiment, the computer program may be downloaded and installed from network through the communication part 1009, installed from the storage part 1008, or installed from the ROM 1002. When the computer program is executed by the CPU 1001, the above-described functions defined in the method of the embodiment of the present disclosure are executed.

It should be noted that in the context of the present disclosure, a computer-readable medium may be a tangible medium, which may contain or store a program for use by the instruction execution system, apparatus, or device or use in combination with the instruction execution system, apparatus, or device. The computer-readable medium may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, including but not limited to: a wire, an optical cable, radio frequency (RF), and the like, or any suitable combination thereof.

The above-described computer-readable medium may be included in the above-described electronic device; or may also exist alone without being assembled into the electronic device.

In some embodiments, a computer program is also provided. The computer program includes instructions, which, when executed by a processor, cause the processor to execute the method of any of the above-described embodiments. For example, the instructions may be embodied as a computer program code.

In an embodiment of the present disclosure, the computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (including a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It is also to be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The modules, components, or units involved in the described embodiments of the present disclosure may be implemented in software or hardware. Wherein, the names of the modules, components or units do not constitute a limitation on the modules, components or units themselves under certain circumstances.

The functions described hereinabove may be performed at least in part by one or more hardware logic components. For example, without limitation, the exemplary hardware logic components that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

According to some embodiments of the present disclosure, a processing method for interactive multimedia content is provided. The method includes: generating a content text of one or more side stories according to a content text of an original story; generating images based on the content text of the original story and the content text of the one or more side stories, wherein the images comprise an image of a character and an image of a scene; and generating the interactive multimedia content according to the content text of the original story, the content text of the one or more side stories and the images.

In some embodiments, the method further includes: displaying a main story of the original story and the one or more side stories, wherein the main story comprises a plurality of main story-line nodes, and each of the one or more side stories comprises a plurality of side story-line nodes.

In some embodiments, the one or more side stories comprise one or more side stories corresponding to each of one or more characters, and the displaying a main story of the original story and the one or more side stories comprises at least one of: displaying, for the each of one or more characters, the main story of the original story and the one or more side stories corresponding to the character; or displaying, in response to a selection operation of a first target character among the one or more characters, the main story of the original story and one or more side stories corresponding to the first target character.

In some embodiments, the displaying a main story of the original story and the one or more side stories comprises at least one of: displaying, for each main story-line except a last main story-line node among the plurality of main story-line nodes, an identifier of a chapter corresponding to the main story-line node, and option information corresponding to the main story-line node in response to the main story-line node deriving a side story-line node; displaying ending information corresponding to the last main story-line node among the plurality of main story-line nodes; displaying, for each side story-line node except a last side story-line node among the plurality of side story-line nodes of the each of the one or more side stories, option information corresponding to the side story-line node, in response to the side story-line node being a side story-line node derived from another node or the side story-line node deriving another side story-line node, wherein the another node comprises a main story-line node or a side story-line node other than the side story-line node; or displaying ending information corresponding to the last side story-line node among the plurality of side story-line nodes of the each of the one or more side stories.

In some embodiments, the method further includes at least one of: displaying, in response to a modification operation on option information of a first target main story-line node among the plurality of main story-line nodes, the modified option information of the first target main story-line node and modified option information of a side story-line node derived from the first target main story-line node; or displaying, in response to a modification operation on a content text of a first target side story-line node among a plurality of side story-line nodes in the one or more side stories, a modified content text of the first target side story-line node.

In some embodiments, the generating a content text of one or more side stories according to a content text of an original story comprises: determining one or more main story-line nodes in a main story of the original story according to the content text of the original story; deriving one or more side story-line nodes as one or more initial side story-line nodes according to each of the one or more main story-line nodes; and generating a plurality of side story-line nodes in a side story-line and expanding content of the plurality of side story-line nodes, according to each of the one or more initial side story-line nodes, to generate the content text of the one or more side stories.

In some embodiments, the one or more side stories comprise one or more side stories corresponding to each of one or more characters, and the determining one or more main story-line nodes in a main story of the original story according to the content text of the original story includes, for the each of one or more characters: selecting one or more key chapters associated with a story of the character and one or more key plots in each of the one or more key chapters from a plurality of chapters of the main story according to the content text of the original story; and generating one or more main story-line nodes associated with the character in the main story of the original story according to the one or more key plots in the each of the one or more key chapters.

In some embodiments, the deriving one or more side story-line nodes as one or more initial side story-line nodes according to each of the one or more main story-line nodes comprises: determining option information of the each of the one or more main story-line nodes according to a key plot corresponding to the each of the one or more main story-line nodes, wherein the option information is configured to describe a selection by a character associated with the each of the one or more main story-line nodes; and generating, for the each of the one or more main story-line nodes, one or more option information different from the option information of the main story-line node and one or more side story-line nodes corresponding to the one or more option information, according to the option information of the main story-line node.

In some embodiments, the expanding content of the plurality of side story-line nodes comprises: expending, for each of the plurality of side story-line nodes, content of the side story-line according to a content text of at least one node in a main story-line node and a side story-line node before the side story-line node and information of a character in a side story to which the side story-line belongs, wherein the information of the character comprises at least one of setting information of the character or relationship information between characters.

In some embodiments, the method further includes at least one of: displaying a description text of the character in the content text of the original story in an association with the image of the character; or displaying a description text of the scene in the content text of the original story in an association with the image of the scene.

In some embodiments, the character comprises a plurality of characters and the scene comprises a plurality of scenes, and the processing method further includes at least one of: regenerating and displaying an image of a second target character in response to an updating operation on an image of the second target character among the plurality of characters; displaying, for each of the plurality of characters, a plurality of images of the character, and determining a first target image as the image of the character in response to a selection operation of the first target image among the plurality of images of the character; regenerating and displaying an image of a first target scene in response to an updating operation on an image of the first target scene in the plurality of scenes; or displaying, for each of the plurality of scenes, a plurality of images of the scene, and determining a second target image as the image of the scene in response to a selection operation on the second target image among the plurality of images of the scene.

In some embodiments, the generating images based on the content text of the original story and the content text of the one or more side stories includes: extracting a description text of each of a plurality of characters from the content text of the original story and the content text of the one or more side stories; generating an image of the each of the plurality of characters according to the description text of the each of the plurality of characters; extracting a description text of each of a plurality of scenes from the content text of the original story and the content text of the one or more side stories; and generating an image of the each of the plurality of scenes according to the description text of the each of the plurality of scenes.

In some embodiments, the image further includes a map, and the processing method further includes: displaying the map; and displaying, in response to a selection operation on a target location in the map, an image of a scene corresponding to the target location in association with a description text of the scene corresponding to the target location.

In some embodiments, the image further includes a map, and the generating images based on the content text of the original story and the content text of the one or more side stories includes: extracting a description text of a plurality of locations from the content text of the original story and a content text of the one or more side stories, wherein the description text of the plurality of locations comprises an orientation relationship between the plurality of locations; and generating the map according to the description text of the plurality of locations.

In some embodiments, the processing method further includes: generating audios according to the content text of the original story and the content text of the one or more side stories, wherein the audios comprise a sound audio of the character and a background sound audio of the scene, wherein the generating the interactive multimedia content according to the content text of the original story, the content text of the one or more side stories and the images includes: generating the interactive multimedia content according to the content text of the original story, and the content text of the one or more side stories, the images and the audios.

In some embodiments, the character comprises a plurality of characters and the scene comprises a plurality of scenes, and the processing method further includes at least one of: displaying sound audios of the plurality of characters in association with description texts of the plurality of characters, and playing a first target audio in response to a selection operation on the first target audio in the sound audios of the plurality of characters; or displaying background sound audios of the plurality of scenes in association with description texts of the plurality of scenes, and playing a second target audio in response to a selection operation on the second target audio in the background sound audios of the plurality of scenes.

In some embodiments, the generating audios according to the content text of the original story and the content text of the one or more side stories includes: extracting setting information of each of the plurality of characters from the content text of the original story and the content text of the one or more side stories; generating a sound audio of the each of the plurality of characters according to the setting information of the each of the plurality of characters; extracting a description text of each of the plurality of scenes from the content text of the original story and the content text of the one or more side stories, and determining a story style; and generating a background sound audio of the each of the plurality of scenes according to the description text of the each of the plurality of scenes and the story style.

In some embodiments, the processing method further includes: displaying a preview interface of the interactive multimedia content, wherein the preview interface comprises a control corresponding to each of a plurality of chapters of the interactive multimedia content; and displaying a preview interface corresponding to a target chapter in response to a trigger operation on a control of the target chapter in the plurality of chapters.

In some embodiments, the processing method further includes: displaying one or more controls of one or more characters, wherein the one or more characters comprise one or more characters appearing in the target chapter, or the one or more characters comprise one or more characters in the interactive multimedia content; and displaying a details interface of a third target character in response to a trigger operation on a control of the third target character among the one or more characters, wherein the details interface comprises at least one of setting information, an image, character relationship information, a sound audio, appearance chapter information or ability information of the third target character.

In some embodiments, the processing method further includes: displaying one or more control of one or more scenes, wherein the one or more scenes comprise one or more scenes in the target chapter or the one or more scenes comprise one or more scenes in the interactive multimedia content; and displaying an image of a second target scene in response to a trigger operation on a control of the second target scene in the one or more scenes.

In some embodiments, the processing method further includes: displaying a control of one or more audios, wherein the one or more audios comprise one or more audios in the target chapter or the one or more scenes comprise one or more audios in the interactive multimedia content; and playing the third target audio in response to a trigger operation on a control of a third target audio in the one or more audios.

In some embodiments, the preview interface corresponding to the target chapter comprises an image of a character in the target chapter, an image of a scene in the target chapter and a text in the target chapter, and the processing method further includes: displaying an edited text in response to an editing operation on the text.

In step S604, the processing method further includes: displaying a character selection interface of the interactive multimedia content; and displaying the interactive multimedia content according to a selected character in response to a selection operation on a character in the interactive multimedia content.

In some embodiments, the processing method further includes: displaying a selection interface in response to a plot development of the interactive multimedia content reaching a plot point where the one or more side stories are generated, wherein the selection interface comprises a plurality pieces of option information; and displaying a screen of the main story or a side story corresponding to a target option information in response to a trigger operation on the target option information among the plurality pieces of option information.

In some embodiments, the processing method further includes: displaying a selection interface in response to a plot development of the interactive multimedia content reaching a plot point where the one or more storylines are generated; receiving input selection information; identifying the selection information and determining a side story corresponding to the selection information; and displaying a screen of the side story corresponding to the selection information.

According to other embodiments of the present disclosure, a processing apparatus for interactive multimedia content is provided. The processing apparatus includes: a text generating module configured to generate a content text of one or more side stories according to a content text of an original story; an image generating module configured to generate images based on the content text of the original story and the content text of the one or more side stories, wherein the images comprise an image of a character and an image of a scene; and a multimedia generating module configured to generate the interactive multimedia content according to the content text of the original story, the content text of the one or more side stories and the images.

According to still other embodiments of the present disclosure, an electronic device is provided. The electronic device includes: one or more processors; and one or more memories coupled to the one or more processors for storing instructions that, when executed by the one or more processors, cause the one or more processors to perform the processing method for interactive multimedia content according to any embodiment of the present disclosure.

According to yet other embodiments of the present disclosure, a computer-readable storage medium is provided. The computer-readable storage medium has a computer program stored thereon that, when executed by a processor, causes the processor to implement the processing method for interactive multimedia content in any embodiment of the present disclosure.

According to still other embodiments of the present disclosure, a computer program is provided. The computer program product includes instructions that, when executed by a processor, cause the processor to perform the processing method for interactive multimedia content in any embodiment of the present disclosure.

According to some embodiments of the present disclosure, a computer program product is provided. The computer program product includes instructions that, when executed by a processor, cause the processor to perform the processing method for interactive multimedia content in any embodiment of the present disclosure.

The above description is only an explanation of some embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features according to the present disclosure (but not limited thereto) having similar functions are replaced with each other to form a technical solution.

In the description provided herein, many specific details are elaborated. However, it is understood that the embodiments of the present invention may be implemented without these specific details. In other cases, in order not to obscure the understanding of the description, the well-known methods, structures and technologies are not demonstrated in detail.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although some specific embodiments of the present disclosure have been described in detail by way of examples, those skilled in the art should understand that the above examples are only for an illustrative purpose, rather than limiting the scope of the present disclosure. Those skilled in the art should appreciate that modifications to the above embodiments may be made without departing from the scope and spirit of the present disclosure. The scope of the present disclosure is defined by the appended claims.

1. A processing method for interactive multimedia content, comprising:
generating a content text of one or more side stories according to a content text of an original story;
generating images based on the content text of the original story and the content text of the one or more side stories, wherein the images comprise an image of a character and an image of a scene; and
generating the interactive multimedia content according to the content text of the original story, the content text of the one or more side stories and the images.

2. The processing method according to claim 1, further comprising:
displaying a main story of the original story and the one or more side stories, wherein the main story comprises a plurality of main story-line nodes, and each of the one or more side stories comprises a plurality of side story-line nodes.

3. The processing method according to claim 2, wherein the one or more side stories comprise one or more side stories corresponding to each of one or more characters, and the displaying a main story of the original story and the one or more side stories comprises at least one of:
displaying, for the each of one or more characters, the main story of the original story and the one or more side stories corresponding to the character; or
displaying, in response to a selection operation of a first target character among the one or more characters, the main story of the original story and one or more side stories corresponding to the first target character.

4. The processing method according to claim 2, wherein the displaying a main story of the original story and the one or more side stories comprises at least one of:
displaying, for each main story-line except a last main story-line node among the plurality of main story-line nodes, an identifier of a chapter corresponding to the main story-line node, and option information corresponding to the main story-line node in response to the main story-line node deriving a side story-line node;
displaying ending information corresponding to the last main story-line node among the plurality of main story-line nodes;
displaying, for each side story-line node except a last side story-line node among the plurality of side story-line nodes of the each of the one or more side stories, option information corresponding to the side story-line node, in response to the side story-line node being a side story-line node derived from another node or the side story-line node deriving another side story-line node, wherein the another node comprises a main story-line node or a side story-line node other than the side story-line node; or
displaying ending information corresponding to the last side story-line node among the plurality of side story-line nodes of the each of the one or more side stories.

5. The processing method according to claim 4, further comprising at least one of:
displaying, in response to a modification operation on option information of a first target main story-line node among the plurality of main story-line nodes, the modified option information of the first target main story-line node and modified option information of a side story-line node derived from the first target main story-line node; or
displaying, in response to a modification operation on a content text of a first target side story-line node among a plurality of side story-line nodes in the one or more side stories, a modified content text of the first target side story-line node.

6. The processing method according to claim 1, wherein the generating a content text of one or more side stories according to a content text of an original story comprises:
determining one or more main story-line nodes in a main story of the original story according to the content text of the original story;
deriving one or more side story-line nodes as one or more initial side story-line nodes according to each of the one or more main story-line nodes; and
generating a plurality of side story-line nodes in a side story-line and expanding content of the plurality of side story-line nodes, according to each of the one or more initial side story-line nodes, to generate the content text of the one or more side stories.

7. The processing method according to claim 6, wherein the one or more side stories comprise one or more side stories corresponding to each of one or more characters, and the determining one or more main story-line nodes in a main story of the original story according to the content text of the original story comprises, for the each of one or more characters:
selecting one or more key chapters associated with a story of the character and one or more key plots in each of the one or more key chapters from a plurality of chapters of the main story according to the content text of the original story; and
generating one or more main story-line nodes associated with the character in the main story of the original story according to the one or more key plots in the each of the one or more key chapters.

8. The processing method according to claim 7, wherein the deriving one or more side story-line nodes as one or more initial side story-line nodes according to each of the one or more main story-line nodes comprises:
determining option information of the each of the one or more main story-line nodes according to a key plot corresponding to the each of the one or more main story-line nodes, wherein the option information is configured to describe a selection by a character associated with the each of the one or more main story-line nodes; and
generating, for the each of the one or more main story-line nodes, one or more option information different from the option information of the main story-line node and one or more side story-line nodes corresponding to the one or more option information, according to the option information of the main story-line node.

9. The processing method according to claim 6, wherein the expanding content of the plurality of side story-line nodes comprises:
expending, for each of the plurality of side story-line nodes, content of the side story-line according to a content text of at least one node in a main story-line node and a side story-line node before the side story-line node and information of a character in a side story to which the side story-line belongs, wherein the information of the character comprises at least one of setting information of the character or relationship information between characters.

10. The processing method according to claim 1, further comprising at least one of:
displaying a description text of the character in the content text of the original story in an association with the image of the character; or
displaying a description text of the scene in the content text of the original story in an association with the image of the scene.

11. The processing method according to claim 10, wherein the character comprises a plurality of characters and the scene comprises a plurality of scenes, and the processing method further comprises at least one of:
regenerating and displaying an image of a second target character in response to an updating operation on an image of the second target character among the plurality of characters;
displaying, for each of the plurality of characters, a plurality of images of the character, and determining a first target image as the image of the character in response to a selection operation of the first target image among the plurality of images of the character;
regenerating and displaying an image of a first target scene in response to an updating operation on an image of the first target scene in the plurality of scenes; or
displaying, for each of the plurality of scenes, a plurality of images of the scene, and determining a second target image as the image of the scene in response to a selection operation on the second target image among the plurality of images of the scene.

12. The processing method according to claim 1, wherein:
the generating images based on the content text of the original story and the content text of the one or more side stories comprises extracting a description text of each of a plurality of characters from the content text of the original story and the content text of the one or more side stories, generating an image of the each of the plurality of characters according to the description text of the each of the plurality of characters, extracting a description text of each of a plurality of scenes from the content text of the original story and the content text of the one or more side stories, and generating an image of the each of the plurality of scenes according to the description text of the each of the plurality of scenes; and/or
the images further comprise a map, and the processing method further comprises displaying the map and displaying, in response to a selection operation on a target location in the map, an image of a scene corresponding to the target location in association with a description text of the scene corresponding to the target location; and/or
the images further comprises a map, and the generating images based on the content text of the original story and the content text of the one or more side stories comprises extracting a description text of a plurality of locations from the content text of the original story and a content text of the one or more side stories, wherein the description text of the plurality of locations comprises an orientation relationship between the plurality of locations, and generating the map according to the description text of the plurality of locations.

13-14. (canceled)

15. The processing method according to claim 1, further comprising:
generating audios according to the content text of the original story and the content text of the one or more side stories, wherein the audios comprise a sound audio of the character and a background sound audio of the scene,
wherein the generating the interactive multimedia content according to the content text of the original story, the content text of the one or more side stories and the images comprises:
generating the interactive multimedia content according to the content text of the original story, and the content text of the one or more side stories, the images and the audios.

16. The processing method according to claim 15, wherein the character comprises a plurality of characters and the scene comprises a plurality of scenes, and the processing method further comprises at least one of: displaying sound audios of the plurality of characters in association with description texts of the plurality of characters, and playing a first target audio in response to a selection operation on the first target audio in the sound audios of the plurality of characters or displaying background sound audios of the plurality of scenes in association with description texts of the plurality of scenes, and playing a second target audio in response to a selection operation on the second target audio in the background sound audios of the plurality of scenes; and/or
the generating audios according to the content text of the original story and the content text of the one or more side stories comprises: extracting setting information of each of the plurality of characters from the content text of the original story and the content text of the one or more side stories, generating a sound audio of the each of the plurality of characters according to the setting information of the each of the plurality of characters, extracting a description text of each of the plurality of scenes from the content text of the original story and the content text of the one or more side stories, and determining a story style, and generating a background sound audio of the each of the plurality of scenes according to the description text of the each of the plurality of scenes and the story style.

17. (canceled)

18. The processing method according to claim 1, further comprising:
displaying a preview interface of the interactive multimedia content, wherein the preview interface comprises a control corresponding to each of a plurality of chapters of the interactive multimedia content; and
displaying a preview interface corresponding to a target chapter in response to a trigger operation on a control of the target chapter in the plurality of chapters.

19. The processing method according to claim 18, further comprising:
displaying one or more controls of one or more characters, wherein the one or more characters comprise one or more characters appearing in the target chapter, or the one or more characters comprise one or more characters in the interactive multimedia content and displaying a details interface of a third target character in response to a trigger operation on a control of the third target character among the one or more characters, wherein the details interface comprises at least one of setting information, an image, character relationship information, a sound audio, appearance chapter information or ability information of the third target character; and/or
displaying one or more control of one or more scenes, wherein the one or more scenes comprise one or more scenes in the target chapter or the one or more scenes comprise one or more scenes in the interactive multimedia content and displaying an image of a second target scene in response to a trigger operation on a control of the second target scene in the one or more scenes; and/or
displaying a control of one or more audios, wherein the one or more audios comprise one or more audios in the target chapter or the one or more scenes comprise one or more audios in the interactive multimedia content and playing the third target audio in response to a trigger operation on a control of a third target audio in the one or more audios; and/or
displaying an edited text in response to an editing operation on a text, wherein the preview interface corresponding to the target chapter comprises an image of a character in the target chapter, an image of a scene in the target chapter and the text in the target chapter.

20-22. (canceled)

23. The processing method according to claim 1, further comprising:
displaying a character selection interface of the interactive multimedia content; and
displaying the interactive multimedia content according to a selected character in response to a selection operation on a character in the interactive multimedia content.

24. The processing method according to claim 23, further comprising:
displaying a selection interface in response to a plot development of the interactive multimedia content reaching a plot point where the one or more side stories are generated, wherein the selection interface comprises a plurality pieces of option information and displaying a screen of the main story or a side story corresponding to a target option information in response to a trigger operation on the target option information among the plurality pieces of option information; and/or
displaying a selection interface in response to a plot development of the interactive multimedia content reaching a plot point where the one or more storylines are generated, receiving input selection information, identifying the selection information and determining a side story corresponding to the selection information and displaying a screen of the side story corresponding to the selection information.

25-26. (canceled)

27. An electronic device, comprising:
one or more processors; and
one or more memories coupled to the one or more processors for storing instructions that, when executed by the one or more processors, cause the one or more processors to:
generate a content text of one or more side stories according to a content text of an original story;
generate images based on the content text of the original story and the content text of the one or more side stories, wherein the images comprise an image of a character and an image of a scene; and
generate the interactive multimedia content according to the content text of the original story, the content text of the one or more side stories and the images.

28. A non-transitory computer readable storage medium, having a computer program stored thereon, wherein the computer program when executed by a processor, causes the processor to:
generate a content text of one or more side stories according to a content text of an original story;
generate images based on the content text of the original story and the content text of the one or more side stories, wherein the images comprise an image of a character and an image of a scene; and
generate the interactive multimedia content according to the content text of the original story, the content text of the one or more side stories and the images.

29-30. (canceled)
